(19) United States
(12) Patent Application Publication
(10) Pub. No.: US 2026/0095653 A1
(43) Pub. Date: Apr. 2, 2026

(54) IMAGING DEVICE AND ELECTRONIC DEVICE

(71) Applicant: SONY SEMICONDUCTOR SOLUTIONS CORPORATION, KANAGAWA (JP)

(72) Inventors: KYOICHI TAKENAKA, KANAGAWA (JP); SEIJI KAYASHIMA, KANAGAWA (JP)

(21) Appl. No.: 19/110,823

(22) PCT Filed: Aug. 18, 2023
(86) PCT No.: PCT/JP2023/029792

§ 371 Date: Mar. 12, 2025

(30) Foreign Application Priority Data
Sep. 22, 2022 (JP) 2022-150895

(51) Int. Cl. H04N 23/667; H04N 23/11; H04N 25/531; H04N 25/532; H04N 25/778

(52) U.S. Cl. CPC H04N 23/667; H04N 23/11; H04N 25/531; H04N 25/532; H04N 25/778

(57) ABSTRACT

To reduce manufacturing cost by simplifying a configuration for switching an electronic shutter method. Provided is an imaging device including: a photoelectric conversion unit that converts light into charge; an overflow transistor connected to the photoelectric conversion unit; a transfer transistor connected to the photoelectric conversion unit; a reset transistor connected to the transfer transistor; a capacitor connected between the transfer transistor and the reset transistor; and an amplifier transistor connected between the transfer transistor and the reset transistor.

### TECHNICAL FIELD

The present technique relates to an imaging device and an electronic device.

### BACKGROUND ART

Electronic shutter methods for an imaging device include a global shutter method and a rolling shutter method. Since the global shutter method and the rolling shutter method have advantages and disadvantages, the electronic shutter methods are preferably switched as necessary.

For example, PTL 1 discloses “an imaging element including a control unit that controls a first reading unit and a second reading unit such that a first signal is read according to the global electronic shutter method and a second signal is read according to the rolling electronic shutter method.”

Furthermore, PTL 2 discloses “an imaging device including a control unit that controls the imaging element such that signals are read according to a global shutter method from a plurality of pixels disposed in a selected first area in a pixel area where a plurality of pixels are disposed and signals are read according to a rolling electronic shutter method from a plurality of pixels disposed in a second area in the pixel area.”

### CITATION LIST

### Patent Literature

### [PTL 1]

JP 2018-6991A

### [PTL 2]

JP 2021-100287A

### SUMMARY

### Technical Problem

The imaging device disclosed in PTL 1 includes a control unit that switches between the global shutter method and the rolling shutter method. The imaging device further includes a readout unit for reading according to the global shutter method and a readout unit for reading according to the rolling shutter method. This complicates the configuration.

The imaging element disclosed in PTL 2 reads signals according to the global shutter method from a plurality of pixels disposed in a selected first area in a pixel area and reads signals according to the rolling electronic shutter method from a plurality of pixels disposed in a second area in the pixel area. This complicates the configuration.

Therefore, the main objective of this technique is to provide an imaging device and an electronic device that are reduced in manufacturing cost by simplifying the configuration for switching the electronic shutter method.

### Solution to Problem

The present technique provides an imaging device including: a photoelectric conversion unit that converts light into charge; an overflow transistor connected to the photoelectric conversion unit; a transfer transistor connected to the photoelectric conversion unit; a reset transistor connected to the transfer transistor; a capacitor connected between the transfer transistor and the reset transistor; and an amplifier transistor connected between the transfer transistor and the reset transistor.

When the overflow transistor is turned on, a signal generated by charge converted through the photoelectric conversion unit may be read according to a first electronic shutter method, and when the overflow transistor is turned off, a signal generated by charge converted through the photoelectric conversion unit is read according to a second electronic shutter method.

The first electronic shutter method may be a global shutter method, and the second electronic shutter method may be a rolling shutter method.

The imaging device may further include a floating diffusion transistor connected between the transfer transistor and the reset transistor.

The reset transistor may be turned on immediately before the transfer transistor is turned on.

The imaging device may further include a select transistor connected to the amplifier transistor.

The overflow transistor may be turned on or off on the basis of the moving speed of a subject to be captured by the imaging device.

The imaging device may further include an image generation unit that generates an image on the basis of a read signal.

The image generation unit may generate an infrared light image according to a difference between a first image generated on the basis of light from a subject not irradiated with infrared light and a second image generated on the basis of light from the subject irradiated with infrared light.

The first image and the second image may be images generated on the basis of signals read according to the first electronic shutter method.

The present technique further provides an electronic device including the imaging device.

The present technique can provide an imaging device and an electronic device that are reduced in manufacturing cost by simplifying the configuration for switching the electronic shutter method. The effects described here are not necessarily limited and may be any of the effects described in the present disclosure.

### BRIEF DESCRIPTION OF DRAWINGS

FIG. 1 illustrates the features of an imaging device according to an embodiment of the present technique.

FIG. 2 is a block diagram illustrating a configuration example of an imaging device 1 according to the embodiment of the present technique.

FIG. 3 is a circuit diagram showing a configuration example of a pixel P according to the embodiment of the present technique.

FIG. 4 is a conceptual diagram showing an example of the driving image of the imaging device 1 according to the embodiment of the present technique.

FIG. 5 is a conceptual diagram showing an example of the driving image of the imaging device 1 according to the embodiment of the present technique.

FIG. 6 is a conceptual diagram showing an example of the driving image of the imaging device 1 according to the embodiment of the present technique.

FIG. 7 is a circuit diagram showing a configuration example of the pixel P according to the embodiment of the present technique.

FIG. 8 is a conceptual diagram showing an example of the driving image of the imaging device 1 according to the embodiment of the present technique.

FIG. 9 is a conceptual diagram showing an example of the driving image of the imaging device 1 according to the embodiment of the present technique.

FIG. 10 is a block diagram illustrating a configuration example of the imaging device 1 according to the embodiment of the present technique.

FIG. 11 is a block diagram illustrating a configuration example of the imaging device 1 according to the embodiment of the present technique.

FIG. 12 is a flowchart showing an example of the steps of an image generation unit 80 according to the embodiment of the present technique.

FIG. 13 shows an example of the use of the imaging devices as image sensors according to the first to fourth embodiments of the present technique.

FIG. 14 is a block diagram showing a configuration example of an imaging device as an electronic device to which the present technique is applied.

FIG. 15 illustrates an example of a schematic configuration of an endoscopic surgery system to which the present technique is applicable.

FIG. 16 is a block diagram showing an example of the functional configurations of a camera head 11102 and a CCU 11201 shown in FIG. 15.

FIG. 17 is a block diagram illustrating a schematic configuration example of a vehicle control system, which is an example of a mobile control system to which the technique according to the present disclosure is applicable.

FIG. 18 illustrates an example of the installation position of an imaging unit 12031.

### DESCRIPTION OF EMBODIMENTS

Hereinafter, preferable embodiments for implementing the present technique will be described with reference to the drawings. The embodiments described below illustrate examples of representative embodiments according to the present technique and do not limit the scope of the present technique. Furthermore, any of the following examples and modifications thereof may be combined in the present technique.

In the description of the embodiments below, configurations may be described using terms with “substantially,” such as substantially parallel or substantially orthogonal. For example, “substantially parallel” means a parallel state in essence, that is, a state of shift from perfect parallelism by, for example, about several percents as well as perfect parallelism. The same applies to other terms with “substantially.” Furthermore, the drawings are schematic diagrams and are not necessarily exact illustrations.

In the drawings, unless otherwise specified, “up” means the upper direction or the upper side in the drawing, “down” means the lower direction or the lower side in the drawing, “left” means the left direction or the left side in the drawing, and “right” means the right direction or the right side in the drawing. Also, the same reference numerals are given to the same or equivalent elements or members in the drawings, and redundant descriptions thereof are omitted.

The descriptions will be given in the following order.
1. First embodiment (Example 1 of imaging device)
(1) Overview
(2) Configuration example of imaging device
(3) Configuration example of pixel
(4) Driving image
2. Second embodiment (Example 2 of imaging device)
3. Third embodiment (Example 3 of imaging device)
4. Fourth embodiment (Example 4 of imaging device)
5. Fifth Embodiment (Example of electronic device)
5-1. Example of use of imaging device to which present technique is applied
5-2. Application example of imaging device to which present technique is applied

### 1. First Embodiment (Example 1 of Imaging Device)

### [(1) Overview]

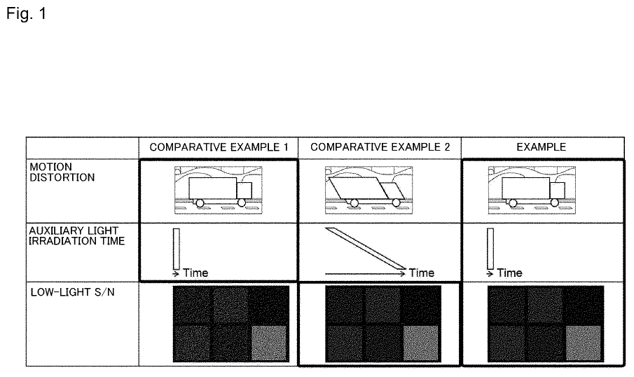

Electronic shutter methods for an imaging device include a global shutter method and a rolling shutter method. It is known that the global shutter method and the rolling shutter method each have advantages and disadvantages. Referring to FIG. 1, the advantages and disadvantages will be described below. FIG. 1 illustrates the characteristics of the imaging device according to an embodiment of the present technique.

In FIG. 1, comparative example 1 shows an example of imaging according to the global shutter method. Comparative example 2 shows an example of imaging according to the rolling shutter method. An example shows an example of imaging by the imaging device according to the embodiment of the present technique.

First, the item “motion distortion” will be described below. In the global shutter method, a plurality of pixels included in a pixel array are exposed to light simultaneously in one plane. Thus, as shown in comparative example 1, the global shutter method is advantageous in that only a small amount of image distortion occurs when an object moving at a predetermined speed is imaged.

On the other hand, in the rolling shutter method, the pixels are exposed to light in a line-sequential manner. Thus, as shown in comparative example 2, the rolling shutter method is disadvantageous in that a large amount of image distortion occurs.

In addition, in order to suppress image distortion in the rolling shutter method, it is effective to increase the frame rate. However, a higher frame rate may increase the output data capacity.

The example of the present technique allows switching between the global shutter method and the rolling shutter method, so that image distortion can be reduced by switching to the global shutter method when a moving object is imaged. Furthermore, the output data capacity can be reduced.

The item “auxiliary light irradiation time” will be described below. For example, a driver monitoring system performs driver authentication processing and driver's condition recognition processing on the basis of sensor data and the like. In the driver monitoring system, infrared light is projected as auxiliary light in order to suppress the influence of external light. As described above, in the global shutter method, a plurality of pixels are exposed to light simultaneously in one plane. Thus, as shown in comparative example 1, the irradiation time of auxiliary light is shortened. This advantageously reduces power consumption.

As described above, in the rolling shutter method, the pixels are exposed to light in a line-sequential manner. Thus, as shown in comparative example 2, the irradiation time of auxiliary light is extended. This disadvantageously increases power consumption.

The example of the present technique allows switching between the global shutter method and the rolling shutter method, so that the irradiation time of auxiliary light can be shortened by switching to the global shutter method.

The item “low-light S/N” will be described below. The global shutter method shown in comparative example 1 has a disadvantage in that noise increases at a low light level. Thus, typically at a low light level, monochrome display using infrared light as auxiliary light is provided instead of color display. Color display is preferable for providing a high-quality image to a user.

On the other hand, the rolling shutter method shown in comparative example 2 has the advantage of low noise even at a low light level. This enables color display.

The example of the present technique allows switching between the global shutter method and the rolling shutter method, so that noise can be reduced even at a low light level by switching to the rolling shutter method.

In this way, the present technique can switch between the global shutter method and the rolling shutter method. Thus, for example, switching can be performed to the global shutter method in order to reduce the irradiation time of auxiliary light, or switching can be performed to the rolling shutter method in order to provide color display even at a low light level.

### [(2) Configuration Example of Imaging Device]

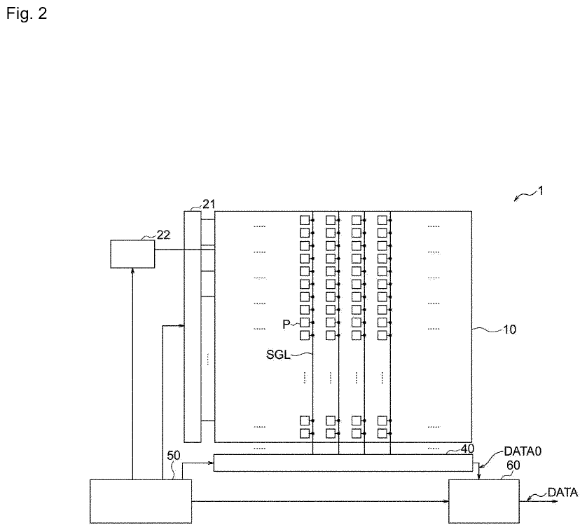

Referring to FIG. 2, a configuration example of the imaging device according to an embodiment of the present technique will be described below. FIG. 2 is a block diagram illustrating a configuration example of an imaging device 1 according to the embodiment of the present technique. As shown in FIG. 2, the imaging device 1 includes a pixel array 10, a scanning unit 21, a signal generation unit 22, a reading unit 40, a control unit 50, and a signal processing unit 60.

The imaging device 1 is supplied with a power supply voltage Vdd, which is not illustrated in FIG. 2. The imaging device 1 operates on the basis of the power supply voltage Vdd.

The pixel array 10 includes a plurality of pixels P arranged in a two-dimensional array.

The scanning unit 21 sequentially drives the plurality of pixels P on the basis of an instruction from the control unit 50. The scanning unit 21 may be configured with, for example, an address decoder and a driver. On the basis of an address signal supplied from the control unit 50, the address decoder selects a pixel line corresponding to an address indicated by the address signal in the pixel array 10. The driver generates a control signal on the basis of an instruction from the address decoder.

The signal generation unit 22 applies a control signal to control lines in the pixel array 10 on the basis of an instruction from the control unit 50.

The reading unit 40 generates an image signal DATA0 by performing AD conversion based on a signal supplied from the pixel array 10 via a vertical signal line SGL.

The control unit 50 controls the operation of the imaging device 1 by supplying control signals to the scanning unit 21, the signal generation unit 22, the reading unit 40, and the signal processing unit 60 and controlling the operations of these circuits. The control unit 50 operates on the basis of the power supply voltage Vdd.

The signal processing unit 60 performs predetermined signal processing based on the image signal DATAO supplied from the reading unit 40, and outputs the processed image signal as an image signal DATA. The signal processing unit 60 operates on the basis of the power supply voltage Vdd.

### [(3) Configuration Example of Pixel]

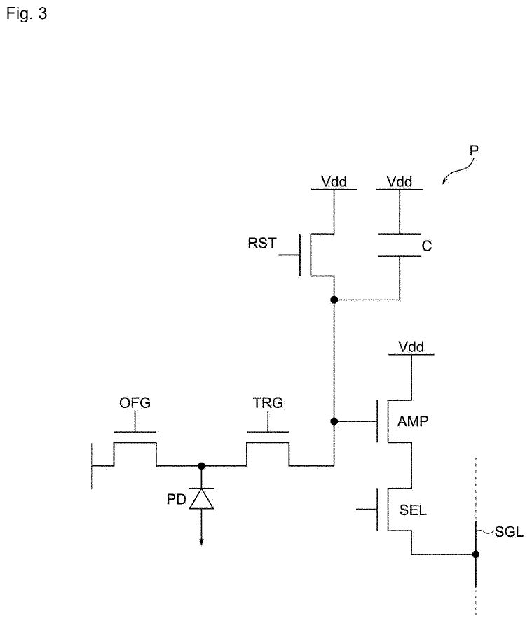

Referring to FIG. 3, a configuration example of the pixels P will be described below. FIG. 3 is a circuit diagram illustrating a configuration example of the pixel P according to the embodiment of the present technique. As shown in FIG. 3, the pixel P includes a photoelectric conversion unit PD, an overflow transistor OFG, a transfer transistor TRG, a reset transistor RST, a capacitor C, an amplifier transistor AMP, and a select transistor SEL.

The photoelectric conversion unit PD is a photodiode that converts light into charge. The photoelectric conversion unit PD generates a charge according to the amount of received light and accumulates the charge therein. The overflow transistor OFG is connected to the photoelectric conversion unit PD. The transfer transistor TRG is connected to the photoelectric conversion unit PD. The reset transistor RST is connected to the transfer transistor TRG. The capacitor C is connected between the transfer transistor RST and the reset transistor RST. The amplifier transistor AMP is connected between the transfer transistor TRG and the reset transistor RST. The select transistor SEL is connected to the amplifier transistor AMP. In this example, the transistors OFG, TRG, RST, AMP, and SEL are N-type MOS (Metal Oxide Semiconductor) transistors.

The overflow transistor OFG discharges the charge accumulated in the photoelectric conversion unit PD. The transfer transistor TRG transfers the charge accumulated in the photoelectric conversion unit PD. The reset transistor RST resets the charge accumulated in the photoelectric conversion unit PD. The amplifier transistor AMP forms a source follower circuit and outputs a signal corresponding to the potential of the drain of the transfer transistor TRG. The select transistor SEL is turned on and makes a connection from the drain of the transfer transistor TRG to the vertical signal line SGL when a pixel is selected. Vdd indicates a power supply voltage.

When the overflow transistor OFG is turned on, the imaging device 1 reads a signal generated by charge converted through the photoelectric conversion unit PD, according to a first electronic shutter method. When the overflow transistor OFG is turned off, the imaging device 1 reads a signal generated by charge converted through the photoelectric conversion unit PD, according to a second electronic shutter method.

The first electronic shutter method may be, for example, a global shutter method. The second electronic shutter method may be, for example, a rolling shutter method.

In this circuit diagram, the overflow transistor OFG and the capacitor C that are constituent elements used for reading according to the global shutter method are added on the basis of constituent elements used for reading according to the rolling shutter method. This allows the imaging device 1 to switch between the global shutter method and the rolling shutter method with a simple configuration. Since the constituent elements used for reading according to the rolling shutter method can be effectively used, the manufacturing cost can be reduced.

### [(4) Driving Image]

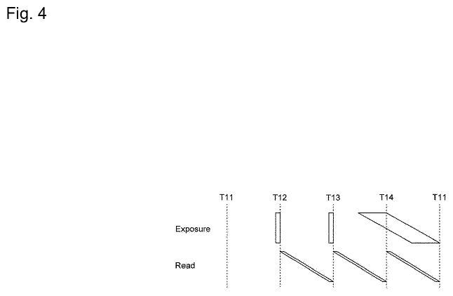

Referring to FIG. 4, switching between the global shutter method and the rolling shutter method will be described below. FIG. 4 is a conceptual diagram showing an example of the driving image of the imaging device 1 according to the embodiment of the present technique. T11 to T14 show driving timings.

At timing T11, the imaging device 1 switches from the rolling shutter method to the global shutter method. The global shutter method is usable for, for example, sensing techniques such as a driver monitoring system. The sensing technique does not need to provide a high-quality image to a user, leading to frequent use of the global shutter method, in which image distortion is small and power consumption is low during imaging of a moving object.

At subsequent timing T12, the imaging device 1 performs simultaneous exposure in one plane (Exposure) and reads signals (Read). Simultaneous exposure in one plane means simultaneous driving of the pixels P in FIG. 2.

At subsequent timing T13, the imaging device 1 irradiates a subject with auxiliary light (e.g., infrared light) and performs simultaneous exposure in one plane (Exposure) and reads signals (Read). As described above, in the driver monitoring system, infrared light is projected as auxiliary light in order to suppress the influence of external light. The influence of external light can be suppressed by calculating a difference between a frame not irradiated with auxiliary light and a frame irradiated with auxiliary light.

Furthermore, at this timing T13, the imaging device 1 switches from the global shutter method to the rolling shutter method. The rolling shutter method can be used for, for example, a viewing technique such as video chat. Since a high-quality image needs to be provided to a user in the viewing technique, the rolling shutter method that enables color display and achieves low noise even at a low light level is frequently used.

The imaging device 1 then starts exposure using the rolling shutter method from before timing T14. In the rolling shutter method, line-sequential exposure is performed and signals are read. “Line sequential” refers to sequential driving of the plurality of pixels P in FIG. 2 one row at a time.

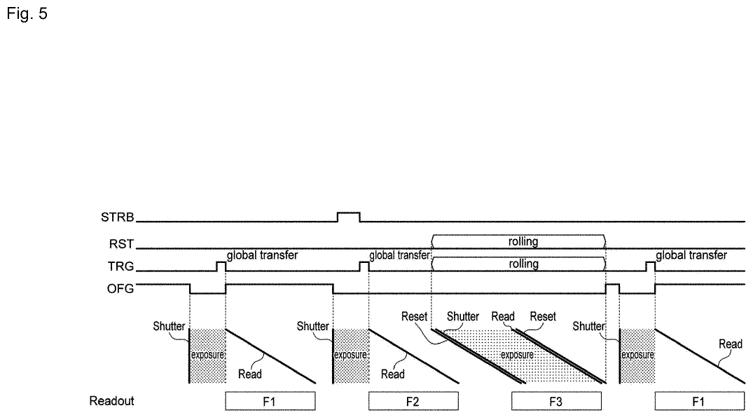

Referring to FIG. 5, the driving image of transistors and the like will be described below. FIG. 5 is a conceptual diagram showing an example of the driving image of the imaging device 1 according to the embodiment of the present technique. In FIG. 5, STRB indicates the control pulse of a light source STRB. RST indicates the control pulse of the reset transistor RST. TRG indicates the control pulse of the transfer transistor TRG. The OFG indicates the control pulse of the overflow transistor OFG. FIG. 5 shows the control pulses of the transistors provided for all the pixels P in FIG. 2. In other words, FIG. 5 shows that the transistors provided for all the pixels P are simultaneously turned on or off.

First, the overflow transistor OFG is placed in an on-state. As shown in FIG. 3, the overflow transistor OFG is connected to the photoelectric conversion unit PD. Therefore, the charge accumulated in the photoelectric conversion unit PD is continuously discharged.

The overflow transistor OFG is then turned off. Thus, the photoelectric conversion unit PD generates an amount of charge corresponding to the amount of received light and accumulates the charge therein. In other words, the imaging device 1 performs exposures according to the global shutter method (Exposure). In the global shutter method, the imaging device 1 performs simultaneous exposure in one plane.

The transfer transistor TRG is then turned on. At this point, the amplifier transistor AMP and the select transistor SEL are placed in an off-state, which is not illustrated. This allows electric charge to be converted by the photoelectric conversion unit PD to be held in the capacitor C.

The transfer transistor TRG is then turned off. The amplifier transistor AMP and the select transistor SEL are also turned on, which is not illustrated. Thus, a signal generated by the charge held in the capacitor C is read according to the global shutter method (Read). This signal constitutes the image signal of a frame F1.

When the transfer transistor TRG is turned off, the overflow transistor OFG is turned on. Accordingly, the charge accumulated inside the photoelectric conversion unit PD is continuously discharged.

The overflow transistor OFG is then turned off again. This allows the photoelectric conversion unit PD to generate an amount of charge corresponding to the amount of received light and accumulate the charge therein. In other words, the imaging device 1 performs exposure according to the global shutter method.

The light source STRB is then turned on. Thus, the light source STRB irradiates a subject with auxiliary light (e.g., infrared light). As described above, for example, in the driver monitoring system, infrared light is projected as auxiliary light in order to suppress the influence of external light.

The light source STRB is then turned off. Thereafter, the transfer transistor TRG is turned on. At this point, the amplifier transistor AMP and the select transistor SEL are placed in an off-state, which is not illustrated. This allows electric charge to be converted by the photoelectric conversion unit PD to be held in the capacitor C.

The transfer transistor TRG is then turned off. The amplifier transistor AMP and the select transistor SEL are also turned on, which is not illustrated. Thus, a signal generated by the charge held in the capacitor C is read according to the global shutter method (Read). This signal constitutes the image signal of a frame F2. The influence of external light can be suppressed by calculating a difference between the frame F2 and the frame F1.

The imaging device 1 can switch the global shutter method and the rolling shutter method by switching the on-state and the off-stage of the overflow transistor OFG. In this case, the overflow transistor OFG is placed in the off state. Thus, the imaging device 1 then performs exposure according to the rolling shutter method in the period of “rolling” indicating the rolling shutter method. The driving timing of the transistors in the rolling shutter method will be described later. In the rolling shutter method, the imaging device 1 performs reset (Reset), exposure (Exposure), and reading (Read) in a line-sequential manner. The read signal constitutes the image signal of a frame F3.

After the period of “rolling,” the overflow transistor OFG is turned on. Thus, the imaging device 1 performs reading according to the global shutter method as in imaging in the frame F1 and the frame F2.

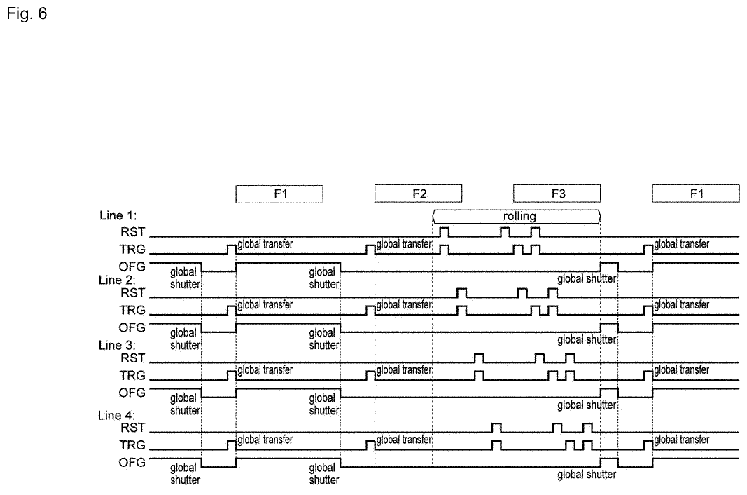

Referring to FIG. 6, the driving image of the transistors in the rolling shutter method will be described below. FIG. 6 is a conceptual diagram showing an example of the driving image of the imaging device 1 according to the embodiment of the present technique.

In FIG. 6, frames F1 to F3 correspond to the frames F1 to F3 shown in FIG. 5. Line 1 indicates the driving timings of the reset transistor RST, the transfer transistor TRG, and the overflow transistor OFG that are provided in the pixel P in the first row of FIG. 2. Likewise, Line 2 indicates the driving timings of the reset transistor RST, the transfer transistor TRG, and the overflow transistor OFG that are included in the pixel P in the second row of FIG. 2. The same applies to Line 3 and Line 4.

The reading of the image signals of the frame F1 and the frame F2 has been described with reference to FIG. 5 and thus a repeated description thereof is omitted. FIG. 6 describes the driving timings of the reset transistor RST, the transfer transistor TRG, and the overflow transistor OFG in the period of “rolling” (see FIG. 5) that indicates the rolling shutter period.

First, the overflow transistor OFG provided in the pixel P in the first row is placed in an off-state. This allows the photoelectric conversion unit PD to generate an amount of charge corresponding to the amount of received light and accumulate the charge therein.

Thereafter, the reset transistor RST provided in the pixel P in the first line is turned on. Thus, the reset transistor RST resets the charge accumulated in the photoelectric conversion unit PD. Moreover, when the reset transistor RST is turned on, the transfer transistor TRG is turned on. The amplifier transistor AMP and the select transistor SEL are placed in an on-state, which is not illustrated. Thus, a signal generated by charge converted by the photoelectric conversion unit PD is read.

Likewise, the driving timings of the reset transistor RST and the transfer transistor TRG provided in each of the pixels P in the second to fourth rows are not synchronized for a predetermined period. In this way, in the rolling shutter method, the imaging device 1 performs reset, exposure, and reading in a line-sequential manner.

Thereafter, in the pixel P in the first row, the reset transistor RST is turned on immediately before the transfer transistor TRG is turned on. At this point, the reset transistor RST does not need to be turned on but is preferably turned on. Since the reset transistor RST is turned on immediately before the transfer transistor TRG is turned on, for example, unnecessary charge (noise) remaining near the gate of the amplifier transistor AMP can be removed. Therefore, the image quality improves.

The transfer transistor TRG is turned on after the reset transistor RST is turned on, so that a signal generated by the charge converted by the photoelectric conversion unit PD is read. The amplifier transistor AMP and the select transistor SEL are placed in an on-state, which is not illustrated.

At the end of the first row, the reset transistor RST and the transfer transistor TRG are turned on. Accordingly, the charge accumulated in the photoelectric conversion unit PD is reset.

Likewise, the reset transistor RST and the transfer transistor TRG provided in each of the pixels P in the second to fourth rows are driven while being shifted by a predetermined period.

After the period of “rolling,” the overflow transistor OFG is turned on. Thus, the imaging device 1 switches from the rolling shutter method to the global shutter method.

The imaging device 1 can be provided in a variety of electronic devices that require switching between the global shutter method and the rolling shutter method, and is not limited to the foregoing driver monitoring system. For example, the imaging device 1 can be provided in a smartphone, a tablet, and a PC. This allows the imaging device 1 to capture an image according to the global shutter method in sensing techniques such as face recognition and color recognition and capture an image according to the rolling shutter method during imaging of photographs and videos.

Furthermore, in an around-view monitor that captures the environment around a vehicle, imaging is typically performed according to the rolling shutter method because the image quality is emphasized. According to the present technique, the overflow transistor OFG and the capacitor C that are constituent elements used for reading according to the global shutter method can be added on the basis of constituent elements used for reading according to the rolling shutter method. This allows effective use of the existing constituents, thereby reducing the manufacturing cost. For example, a light source of LiDAR used for imaging according to the rolling shutter method can be used as a light source for emitting auxiliary light in imaging according to the global shutter method.

The above description of the imaging device according to the first embodiment of the present technique can be applied to other embodiments of the present technique unless any particular technical contradiction arises.

### 2. Second Embodiment (Example 2 of Imaging Device)

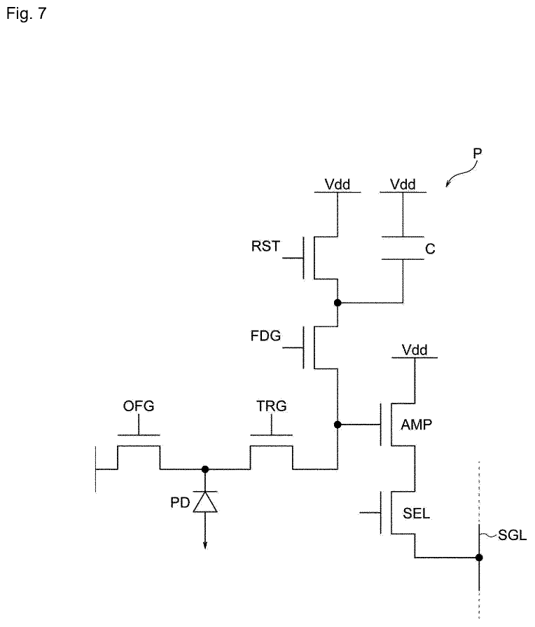

An imaging device according to an embodiment of the present technique may further include a floating diffusion transistor. Referring to FIG. 7, this configuration will be described below. FIG. 7 is a circuit diagram illustrating a configuration example of a pixel P according to the embodiment of the present technique. As shown in FIG. 7, the pixel P further includes a floating diffusion transistor FDG connected between a transfer transistor TRG and a reset transistor RST.

With this configuration, the imaging device 1 can switch an S/N-oriented (LCG: Low Conversion Gain) mode and a sensitivity-oriented (HCG: High Conversion Gain) mode. When the floating diffusion transistor FDG is placed in an on-stage, the imaging device 1 switches to the S/N-oriented mode. Charge to be converted by a photoelectric conversion unit PD is accumulated in the photoelectric conversion unit PD and a capacitor C. Since a large amount of charge can be accumulated, the imaging device 1 can reduce noise.

When the floating diffusion transistor FDG is placed in an on-state, the imaging device 1 switches to the sensitivity-oriented mode. Charge to be converted by the photoelectric conversion unit PD is accumulated in the photoelectric conversion unit PD. Since a small amount of charge can be accumulated, the imaging device 1 can sense a small change in the amount of charge.

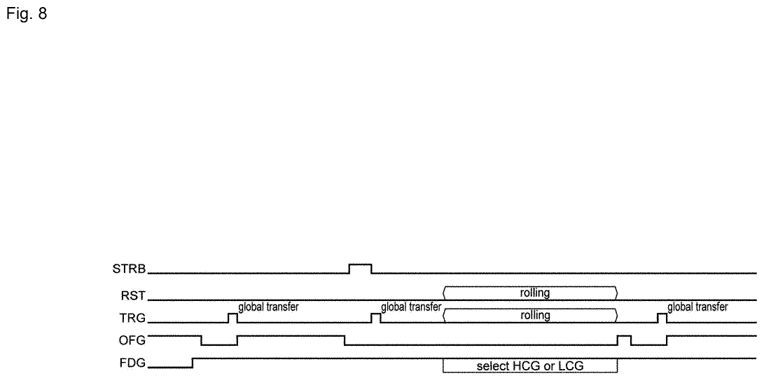

Referring to FIG. 8, the driving timing of the floating diffusion transistor FDG will be described below. FIG. 8 is a conceptual diagram showing an example of the driving image of the imaging device 1 according to the embodiment of the present technique. In FIG. 8, FDG indicates the control pulse of the floating diffusion transistor FDG.

FIG. 8 shows the control pulses of the transistors provided for all the pixels P in FIG. 2. In other words, FIG. 8 shows that the transistors provided for all the pixels P are simultaneously turned on or off.

First, the floating diffusion transistor FDG switches from an off state to an on state. With this configuration, the imaging device 1 switches to the S/N-oriented mode. As described above, the global shutter method has a disadvantage in that noise increases at a low light level. Thus, the imaging device 1 can reduce noise by switching to the S/N-oriented mode.

Thereafter, exposure and reading are performed twice according to the global shutter method. The exposure and reading were described above, and thus the repeated description thereof is omitted.

The imaging device 1 can switch between the global shutter method and the rolling shutter method. Therefore, the imaging device 1 then performs exposure according to the rolling shutter method in the period of “rolling” indicating the rolling shutter method. The driving timing of the transistor according to the rolling shutter method was described above, and thus the repeated description thereof is omitted.

When the floating diffusion transistor FDG is turned off in the period of “rolling” indicating the rolling shutter method, the imaging device 1 switches to the sensitivity-oriented mode. If the floating diffusion transistor FDG is continuously placed in an on-state, the imaging device 1 keeps the S/N-oriented mode.

The above description of the imaging device according to the second embodiment of the present technique can be applied to other embodiments of the present technique unless any particular technical contradiction arises.

### 3. Third Embodiment (Example 3 of Imaging Device)

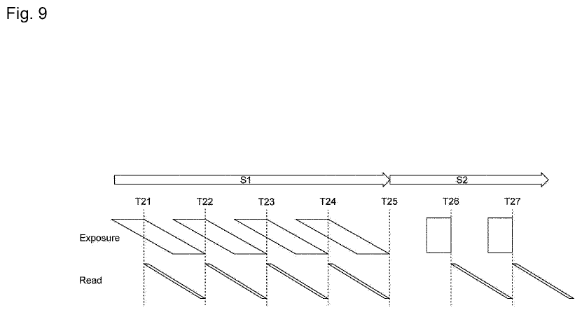

The global shutter method and the rolling shutter method are preferably switched on the basis of the moving speed of a subject to be captured by the imaging device 1. Referring to FIG. 9, the switching will be described below. FIG. 9 is a conceptual diagram showing the driving image of the imaging device 1 according to the embodiment of the present technique. T21 to T27 indicate driving timings.

In a low-speed movement period S1 in which a subject moves at low speed, image distortion is small because of the low speed, so that the rolling shutter method capable of high quality imaging may be used. In a high-speed movement period S2 in which a subject moves at high speed, the global shutter method is preferably used to reduce image distortion.

In other words, the imaging device 1 captures an image according to the rolling shutter method at timings T21 to T24. Thereafter, the imaging device 1 switches from the rolling shutter method to the global shutter method at timing T25. The imaging device 1 then captures an image according to the global shutter method at timings T26 and T27. The switching to the global shutter method can reduce image distortion. In addition, a higher frame rate is not necessary for suppressing image distortion in the rolling shutter method, thereby reducing the capacity of output data.

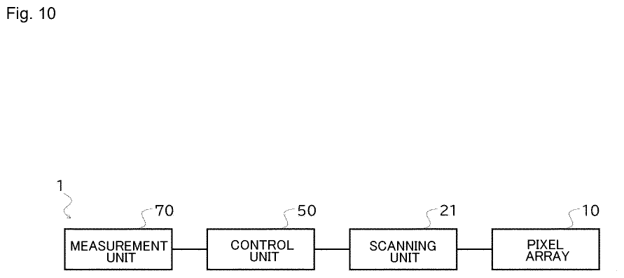

Referring to FIG. 10, a configuration example of the imaging device 1 at this point will be described below. FIG. 10 is a block diagram illustrating the configuration example of the imaging device 1 according to the embodiment of the present technique. As shown in FIG. 10, the imaging device 1 further includes a measurement unit 70. A control unit 50, a scanning unit 21, and a pixel array 10 were described above with reference to FIG. 2, and thus the repeated description thereof is omitted.

The measurement unit 70 measures the moving speed of a subject and transmits moving speed information to the control unit 50. The control unit 50 drives each of the pixels of the pixel array 10 through the scanning unit 21 on the basis of the moving speed information. An overflow transistor (not illustrated in FIG. 10) provided in each of the pixels is turned on or off on the basis of the moving speed of a subject captured by the imaging device 1. Thus, for example, when the moving speed of the subject exceeds a predetermined value, an overflow transistor OFG is turned on. This allows the imaging device 1 to switch from the rolling shutter method to the global shutter method.

In order to measure the moving speed of a subject, the measurement unit 70 may include at least one of an ultrasonic sensor, an imaging device, a radar, and a LiDAR unit. Alternatively, the measurement unit 70 may include, but not limited to, an infrared sensor, a radio wave-based target detection sensor, a laser-based target detection sensor, a vehicle speed sensor, a travel distance sensor, a yaw rate sensor, a speed meter, global positioning (GPS), a steering-angle detection sensor, a vehicle moving-direction detection sensor, and a magnetometer and/or touch sensor.

In addition, the measurement unit 70 may be unused in switching between the global shutter method and the rolling shutter method. For example, the global shutter method and the rolling shutter method may be switched in response to a user operation.

The above description of the imaging device according to the third embodiment of the present technique can be applied to other embodiments of the present technique unless any particular technical contradiction arises.

### 4. Fourth Embodiment (Example 4 of Imaging Device)

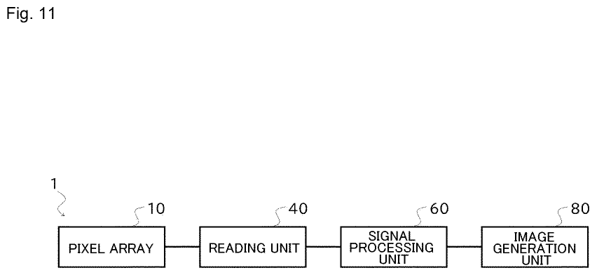

An imaging device according to an embodiment of the present technique may further include an image generation unit that generates an image on the basis of a signal read according to a global shutter method or a rolling shutter method. Referring to FIG. 11, this configuration will be described below. FIG. 11 is a block diagram illustrating a configuration example of an imaging device 1 according to the embodiment of the present technique. As shown in FIG. 11, the imaging device 1 includes an image generation unit 80 that generates an image on the basis of a read signal. A pixel array 10, a reading unit 40, and a signal processing unit 60 were described above with reference to FIG. 2, and thus the repeated description thereof is omitted.

A signal read through the pixel array 10, the reading unit 40, and the signal processing unit 60 is transmitted to the image generation unit 80. The image generation unit 80 generates an image on the basis of the signal. The image generation unit 80 may include, for example, an ISP (Image Signal Processor), a CPU (Central Processing Unit), and a GPU (Graphics Processing Unit).

As described above, for example, in a driver monitoring system, infrared light is projected as auxiliary light in order to suppress the influence of external light. The influence of external light can be suppressed by calculating a difference between a frame not irradiated with auxiliary light and a frame irradiated with auxiliary light.

In this case, the image generation unit 80 preferably generates an infrared light image according to a difference between a first image generated on the basis of light from a subject not irradiated with infrared light and a second image generated on the basis of light from the subject irradiated with infrared light. The influence of external light can be suppressed by calculating the difference.

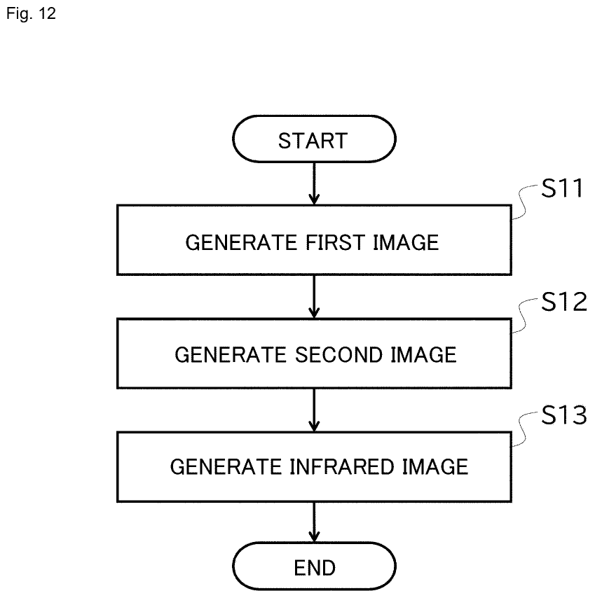

Referring to FIG. 12, the calculation of the image generation unit 80 at this point will be described below. FIG. 12 is a flowchart showing an example of the steps of the image generation unit 80 according to the embodiment of the present technique.

As shown in FIG. 12, first, the image generation unit 80 generates the first image in step S11. The first image is generated on the basis of light from a subject not irradiated with infrared light.

The image generation unit 80 then generates a second image in step S12. The second image is generated on the basis of light from a subject irradiated with infrared light.

Thereafter, in step S13, the image generation unit 80 generates an infrared image according to the difference between the first image and the second image.

The first image and the second image may be images generated on the basis of signals read according to a first electronic shutter method (e.g., the global shutter method). In the first electronic shutter method, image distortion is small when a moving object is imaged. Thus, the imaging device 1 captures an image according to the first electronic shutter method in, for example, a driver monitoring system, thereby acquiring a driver's condition with high accuracy.

The calculation performed by the image generation unit 80 can be implemented by a program. The image generation unit 80 performs calculations by reading this program.

The program can be stored and supplied to a computer using various types of non-transitory computer-readable media. Non-transitory computer-readable media include various types of tangible storage media. Examples of non-transitory computer-readable media include magnetic recording media (for example, floppy disks, magnetic tapes and hard disk drives), magneto-optical recording media (for example, magneto-optical discs), a compact disc read only memory (CD-ROM), CD-R, CD-R/W, and a semiconductor memory (for example, a mask ROM, a programmable ROM (PROM), an erasable PROM (EPROM), a flash ROM, and a random access memory (RAM)). The program may also be supplied to the computer by various types of transitory computer readable media. Examples of the transitory computer-readable media include electrical signals, optical signals, and electromagnetic waves. The transitory computer-readable media can deliver the program to the computer via wired communication channels such as electrical wires and optical fibers, or wireless communication channels.

The above description of the imaging device according to the fourth embodiment of the present technique can be applied to other embodiments of the present technique unless any particular technical contradiction arises.

### 5. Fifth Embodiment (Example of Electronic Device)

An electronic device according to a fifth embodiment of the present technique is an electronic device equipped with the imaging device according to any one of the first to fourth embodiments of the present technique. The following is a detailed description of the electronic device according to the fifth embodiment of the present technique.

### [5-1. Example of Use of Imaging Device to Which Present Technique is Applied]

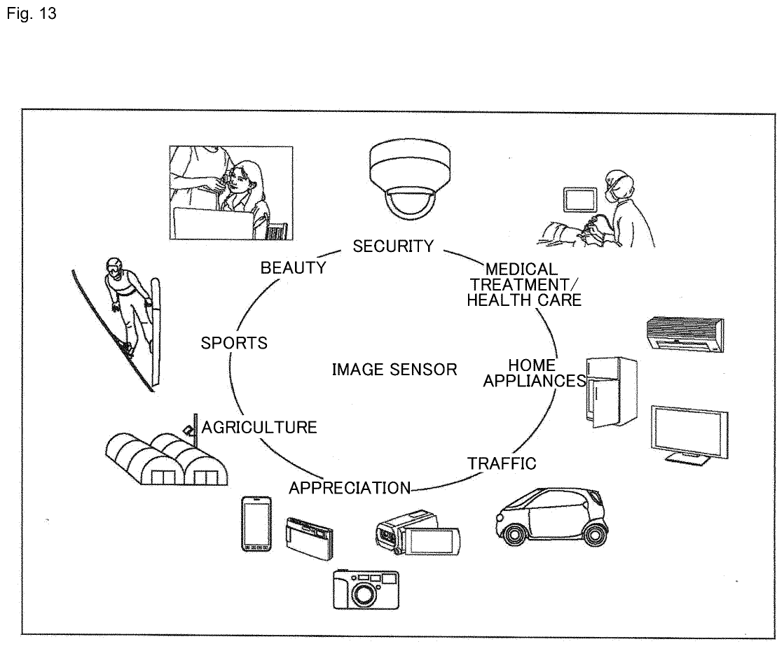

FIG. 13 shows an example of the use of the imaging devices as image sensors according to the first to fourth embodiments of the present technique.

The imaging devices according to the first to fourth embodiments can be used in, for example, various cases where light such as visible light, infrared light, ultraviolet light, and X rays is sensed as follows: In other words, as shown in FIG. 13, the imaging device according to any one of the first to fourth embodiments can be used for devices that are used in, for example, the field of appreciation in which an image provided for appreciation is captured, the field of traffic, the field of home appliances, the field of medical treatment and health care, the field of security, the field of beauty, the field of sports, and the field of agriculture.

Specifically, in the field of appreciation, the imaging device according to any one of the first to fourth embodiments can be used for devices that capture images provided for appreciation, the devices including a digital camera, a smartphone, and a mobile phone with a camera function.

In the field of traffic, for example, for safe driving such as automatic stop and recognition of driver's conditions, the imaging device according to any one of the first to fourth embodiments can be used for devices provided for traffic, such as an in-vehicle sensor that captures images of, for example, the front, rear, surroundings, and inside of a vehicle, a monitoring camera that monitors traveling vehicles and roads, and a distance measuring sensor that measures a distance between vehicles.

In the field of home appliances, for example, in order to image a user's gesture and operate equipment in response to the gesture, the imaging device according to any one of the first to fourth embodiments can be used for devices provided for home appliances such as a television receiver, a refrigerator, and an air conditioner.

In the field of medical treatment and health care, the imaging device according to any one of the first to fourth embodiments can be used for devices provided for medical treatment and health care, for example, an endoscope and a device that performs angiography by receiving infrared light.

In the field of security, the imaging device according to any one of the first to fourth embodiments can be used for devices provided for security, for example, a surveillance camera for crime prevention and a camera for person authentication.

In the field of beauty, the imaging device according to any one of the first to fourth embodiments can be used for devices provided for beauty, for example, a skin measuring instrument that images the skin and a microscope that images the scalp.

In the field of sports, the imaging device according to any one of the first to fourth embodiments can be used for devices provided for sports, for example, an action camera and a wearable camera for sports applications.

In the field of agriculture, the imaging device according to any one of the first to fourth embodiments can be used for devices provided for agriculture, for example, a camera that monitors the conditions of fields and crops.

The imaging device according to any one of the first to fourth embodiments can be applied to various electronic devices including an imaging device such as a digital still camera or a digital video camera, a cellular phone having an imaging function, or any other device with an imaging function.

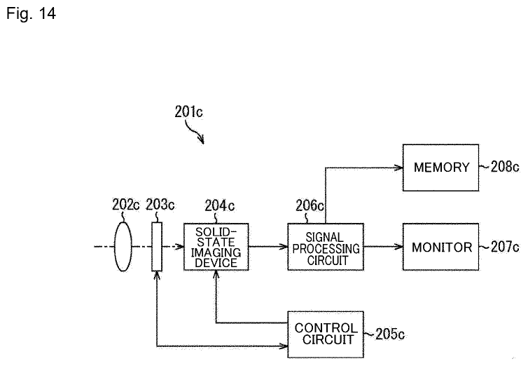

FIG. 14 is a block diagram illustrating a configuration example of the imaging device as an electronic device to which the present technique is applied.

An imaging device 201c illustrated in FIG. 14 is configured to include an optical system 202c, a shutter device 203c, a solid-state imaging device 204c, a drive circuit (control circuit) 205c, a signal processing circuit 206c, a monitor 207c, and a memory 208c and can capture still-images and moving images.

The optical system 202c is configured to include one or a plurality of lenses and directs light from a subject (incident light) to the solid-state imaging device 204c and forms an image on the light-receiving surface of the solid-state imaging device 204c.

The shutter device 203c is disposed between the optical system 202c and the solid-state imaging device 204c and controls a light emission period and a light shielding period for the solid-state imaging device 204c under the control of the drive circuit (control circuit) 205c.

The solid-state imaging device 204c accumulates signal charges for a certain period of time according to the light focused on the light-receiving surface to form images via the optical system 202c and the shutter device 203c. The signal charges accumulated in the solid-state imaging device 204c are transferred according to the drive signals (timing signals) supplied from the drive circuit (control circuit) 205c.

The drive circuit (control circuit) 205c outputs a drive signal that controls the transfer operation of the solid-state imaging device 204c and the shutter operation of the shutter device 203c and drives the solid-state imaging device 204c and the shutter device 203c.

The signal processing circuit 206c performs various types of signal processing on signal charge output from the solid-state imaging device 204c. An image (image data) obtained by the signal processing performed by the signal processing circuit 206c is supplied to the monitor 207c and displayed, or supplied to the memory 208c and stored (recorded).

### [5-2. Application Example of Imaging Device to Which Present Technique is Applied]

The following is a description of application examples (application examples 1 and 2) of the imaging devices (such as an image sensor) described in the first to fourth embodiments. The imaging devices in the embodiments can be applied to electronic devices in various fields. As an example, an endoscopic surgery system (application example 1) and a mobile unit (application example 2) will be described below. It should be noted that the imaging device described in the section of [5-1. Example of use of imaging device to which present technique is applied] is also an application example of the imaging device (image sensor) described in the first to fourth embodiments of the present technique.

### Application Example 1

### [Example of Application to Endoscopic Surgery System]

The present technique can be applied to various products. For example, the technique according to the present disclosure (the present technique) may be applied to an endoscopic surgery system.

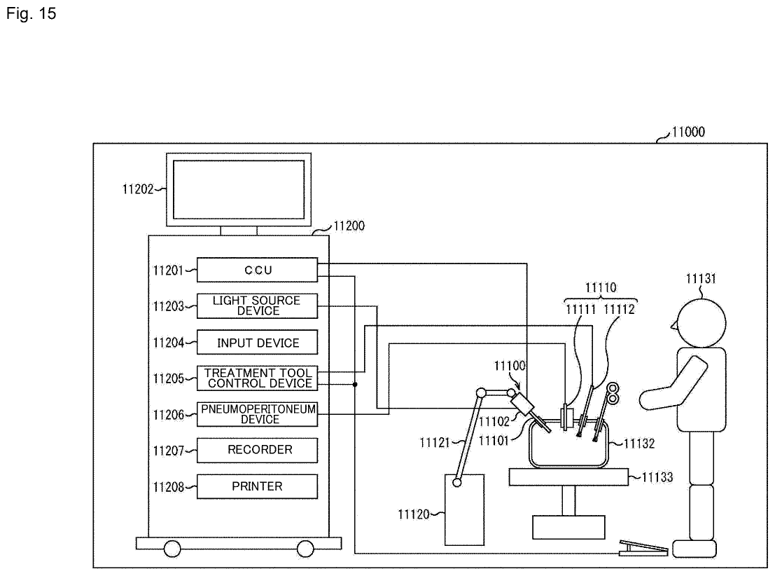

FIG. 15 illustrates an example of a schematic configuration of an endoscopic surgery system to which the present technique is applicable.

FIG. 15 shows a state in which an operator (doctor) 11131 is performing a surgical operation on a patient 11132 on a patient bed 11133 by using an endoscopic surgery system 11000. As illustrated in FIG. 15, the endoscopic surgery system 11000 includes an endoscope 11100, other surgical instruments 11110 such as a pneumoperitoneum tube 11111 and an energy treatment tool 11112, a support arm device 11120 that supports the endoscope 11100, and a cart 11200 equipped with various devices for endoscopic surgery.

The endoscope 11100 includes a lens barrel 11101 having a region to be inserted with a predetermined length into a body cavity of the patient 11132 from the distal end of the endoscope, and a camera head 11102 connected to the proximal end of the lens barrel 11101. In the illustrated example, the endoscope 11100 is configured as a so-called rigid endoscope having the rigid lens barrel 11101. The endoscope 11100 may be configured as a so-called flexible endoscope having a flexible lens barrel.

The distal end of the lens barrel 11101 is provided with an opening where an objective lens is fit. Alight source device 11203 is connected to the endoscope 11100, light generated by the light source device 11203 is guided to the distal end of the lens barrel 11101 by a light guide extended to the inside of the lens barrel 11101, and the light is projected to an observation target in the body cavity of the patient 11132 through the objective lens. The endoscope 11100 may be a direct-viewing endoscope, an oblique-viewing endoscope, or a side-viewing endoscope.

An optical system and an imaging element are provided inside the camera head 11102, and reflected light (observation light) from the observation target is concentrated on the imaging element by the optical system. The imaging element photoelectrically converts the observation light, and an electrical signal corresponding to the observation light, that is, an image signal corresponding to an observation image is formed. The image signal is transmitted to a camera control unit (CCU: Camera Control Unit) 11201 as RAW data.

The CCU 11201 includes a CPU (Central Processing Unit) or a GPU (Graphics Processing Unit) and controls the entire operations of the endoscope 11100 and a display device 11202. In addition, the CCU 11201 receives an image signal from the camera head 11102 and performs various types of image processing for displaying an image based on the image signal. For example, development processing (demosaic processing) is performed on the image signal.

The display device 11202 displays the image based on the image signal subjected to the image processing by the CCU 11201, under the control of the CCU 11201.

The light source device 11203 includes, for example, a light source such as an LED (Light Emitting Diode) and supplies the endoscope 11100 with irradiation light when photographing a surgical site or the like.

An input device 11204 is an input interface for the endoscopic surgery system 11000. The user can input various types of information or instructions to the endoscopic surgery system 11000 via the input device 11204. For example, the user inputs an instruction to change imaging conditions (including the type of irradiation light, a magnification, and a focal length) of the endoscope 11100.

A treatment tool control device 11205 controls driving of the energy treatment tool 11112 for cauterization or incision of a tissue or sealing of blood vessel. A pneumoperitoneum device 11206 feeds gas into the body cavity of the patient 11132 via the pneumoperitoneum tube 11111 in order to inflate the body cavity for the purpose of securing a field of view through the endoscope 11100 and a working space of the operator. A recorder 11207 is a device capable of recording various types of information on surgery. A printer 11208 is a device capable of printing various types of information on surgery in various formats such as text, images, and graphs.

The light source device 11203 that supplies the endoscope 11100 with irradiation light for capturing the image of the surgical site can be composed of, for example, an LED, a laser light source, or a white light source configured as a combination thereof. When a white light source is configured as a combination of RGB laser light sources, the output intensity and the output timing of each color (each wavelength) can be controlled with high accuracy, allowing the light source device 11203 to adjust the white balance of the captured image. In this case, by time-divisionally irradiating an observation target with laser light from the RGB laser light source and controlling driving of the imaging element of the camera head 11102 in synchronization with the irradiation timing, images corresponding to RGB can be time-divisionally captured. According to this method, a color image can be obtained without providing a filter for the imaging element.

Furthermore, driving of the light source device 11203 may be controlled such that the intensity of output light is changed at predetermined time intervals. The driving of the imaging element of the camera head 11102 is controlled in synchronization with the timing of changing the intensity of the light, and images are acquired in a time division manner and are combined, so that an image having a high dynamic range can be generated without so-called blackout and whiteout.

The light source device 11203 may be configured to supply light in a predetermined wavelength band corresponding to special light observation. In the special light observation, for example, by emitting light in a band narrower than that of radiation light (that is, white light) during normal observation using wavelength dependence of light absorption in a body tissue, so-called narrow band light observation (Narrow Band Imaging) is performed in which a predetermined tissue such as a blood vessel in a mucous membrane surface layer is imaged with a high contrast. Alternatively, in the special light observation, fluorescence observation may be performed to obtain an image by fluorescence generated by emitting excitation light. In the fluorescence observation, excitation light can be emitted to a body tissue to observe fluorescence from the body tissue (autofluorescence observation), or a reagent such as indocyanine green (ICG) can be locally injected to a body tissue and excitation light corresponding to a fluorescence wavelength of the reagent can be emitted to the body tissue to obtain a fluorescence image. The light source device 11203 can be configured to supply narrow band light and/or excitation light corresponding to such special light observation.

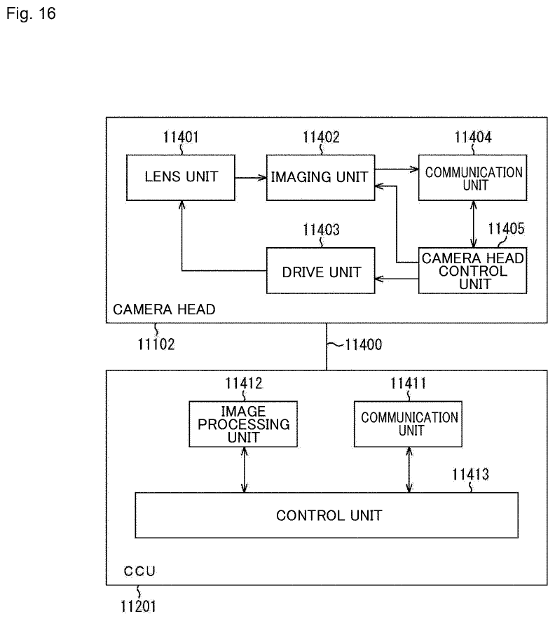

FIG. 16 is a block diagram showing an example of the functional configurations of the camera head 11102 and the CCU 11201 shown in FIG. 15.

The camera head 11102 includes a lens unit 11401, an imaging unit 11402, a drive unit 11403, a communication unit 11404, and a camera head control unit 11405. The CCU 11201 has a communication unit 11411, an image processing unit 11412, and a control unit 11413. The camera head 11102 and the CCU 11201 are communicatively connected to each other by a transmission cable 11400.

The lens unit 11401 is an optical system provided in a connection portion for connection to the lens barrel 11101. Observation light taken from the distal end of the lens barrel 11101 is guided to the camera head 11102 and is incident on the lens unit 11401. The lens unit 11401 is configured in combination with a plurality of lenses including a zoom lens and a focus lens.

The imaging unit 11402 includes an imaging device (image sensor). The imaging element constituting the imaging unit 11402 may be one element (a so-called single plate type) or a plurality of elements (a so-called multi-plate type). When the imaging unit 11402 is configured as a multi-plate type, for example, image signals corresponding to respective RGB are generated by the imaging elements, and a color image may be obtained by combining the image signals. Alternatively, the imaging unit 11402 may be configured to include a pair of imaging elements for acquiring each of image signals for the right eye and the left eye that correspond to 3D (Dimensional) display. The provision of 3D display allows the operator 11131 to more accurately recognize the depth of a living tissue in a surgical site. When the imaging unit 11402 is configured as a multi-plate type, a plurality of systems of lens units 11401 may be provided for the imaging elements.

The imaging unit 11402 does not always need to be provided in the camera head 11102. For example, the imaging unit 11402 may be provided immediately behind the objective lens inside the lens barrel 11101.

The drive unit 11403 includes an actuator, and the zoom lens and the focus lens of the lens unit 11401 are moved by a predetermined distance along an optical axis under the control of the camera head control unit 11405. Accordingly, the magnification and focus of the image captured by the imaging unit 11402 can be adjusted appropriately.

The communication unit 11404 is configured using a communication device for transmitting and receiving various types of information to and from the CCU 11201. The communication unit 11404 transmits the image signal obtained from the imaging unit 11402 as RAW data to the CCU 11201 via the transmission cable 11400.

The communication unit 11404 receives a control signal for controlling driving of the camera head 11102 from the CCU 11201 and supplies the camera head control unit 11405 with the control signal. The control signal includes, for example, information on imaging conditions such as information on the designation of a frame rate of the captured image, information on the designation of an exposure value at the time of imaging, and/or information on the designation of the magnification and focus of the captured image.

The imaging conditions, such as the frame rate, the exposure value, the magnification, and the focal point, may be appropriately specified by the user, or may be automatically set by the control unit 11413 of the CCU 11201 on the basis of the acquired image signal. In the latter case, the endoscope 11100 has a so-called AE (Auto Exposure) function, a so-called AF (Auto Focus) function, and a so-called AWB (Auto White Balance) function.

The camera head control unit 11405 controls driving of the camera head 11102 on the basis of a control signal from the CCU 11201 received via the communication unit 11404.

The communication unit 11411 includes a communication device that transmits and receives various types of information to and from the camera head 11102. The communication unit 11411 receives an image signal transmitted via the transmission cable 11400 from the camera head 11102.

Furthermore, the communication unit 11411 transmits the control signal for controlling the driving of the camera head 11102 to the camera head 11102. The image signal or the control signal can be transmitted through electric communications or optical communications or the like.

The image processing unit 11412 performs various types of image processing on the image signal that is the RAW data transmitted from the camera head 11102.

The control unit 11413 performs various types of control on imaging of a surgical site by the endoscope 11100 and display of a captured image obtained through imaging of a surgical site or the like. For example, the control unit 11413 generates the control signal for controlling the driving of the camera head 11102.

In addition, the control unit 11413 causes the display device 11202 to display a captured image showing a surgical site or the like on the basis of an image signal subjected to the image processing by the image processing unit 11412. At this point, the control unit 11413 may recognize various objects in the captured image using various image recognition techniques. For example, the control unit 11413 can recognize surgical instruments such as forceps, a specific biological site, bleeding, mist or the like at the time of use of the energy treatment tool 11112 by detecting a shape and a color or the like of an edge of an object included in the captured image. When the display device 11202 is caused to display a captured image, the control unit 11413 may superimpose various types of surgery support information on an image of the surgical site by using a recognition result of the captured image. The surgery support information is superimposed on the display and is presented to the operator 11131, so that a burden on the operator 11131 can be reduced and the operator 11131 can reliably perform a surgical operation.

The transmission cable 11400 that connects the camera head 11102 and the CCU 11201 is an electrical signal cable compatible with communication of electrical signals, an optical fiber compatible with optical communication, or a composite cable thereof.

Although wired communication is performed using the transmission cable 11400 in the illustrated example, radio communications may be performed between the camera head 11102 and the CCU 11201.

An example of an endoscopic surgery system to which the technique according to the present disclosure is applicable has been described above. The technique according to the present disclosure can be applied to the endoscope 11100, the camera head 11102 (the imaging unit 11402 thereof), and the like among the configurations described above. Specifically, the solid-state imaging device according to the present technique can be applied to the imaging unit 10402. The technique according to the present disclosure is applied to the endoscope 11100 and the camera head 11102 (the imaging unit 11402 thereof) or the like, thereby improving the performance.

The endoscopic surgery system has been described as an example. The technique according to the present disclosure may be applied to other systems, for example, a microscopic surgery system.

### Application Example 2

### [Example of Application to Mobile Unit]

The technique of the present disclosure (the present technique) can be applied to various products. For example, the technique according to the present disclosure may be implemented as a device equipped in any type of mobile units such as an automobile, an electric vehicle, a hybrid electric vehicle, a motorcycle, a bicycle, a personal mobility device, an airplane, a drone, a ship, and a robot.

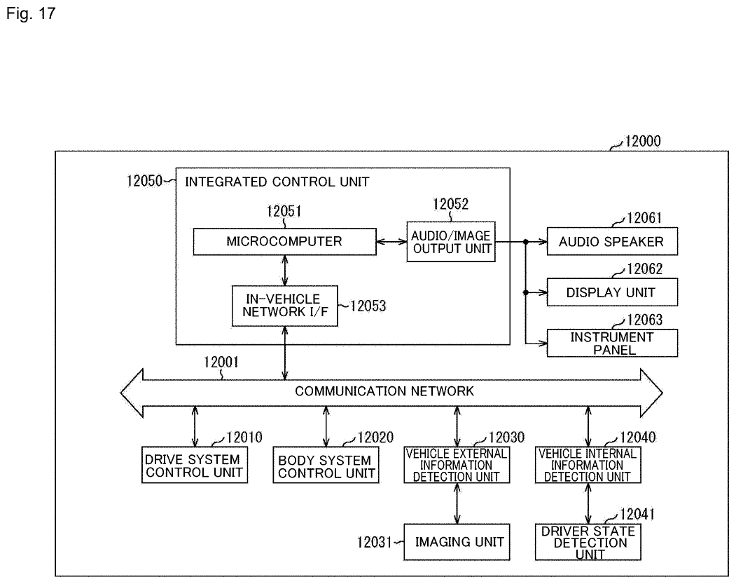

FIG. 17 is a block diagram illustrating a schematic configuration example of a vehicle control system, which is an example of a mobile control system to which the technique according to the present disclosure is applicable.

A vehicle control system 12000 includes a plurality of electronic control units connected to one another via a communication network 12001. In the example illustrated in FIG. 17, the vehicle control system 12000 includes a drive system control unit 12010, a body system control unit 12020, a vehicle external information detection unit 12030, a vehicle internal information detection unit 12040, and an integrated control unit 12050. A microcomputer 12051, an audio/image output unit 12052, and an in-vehicle network I/F (interface) 12053 are illustrated as the functional configuration of the integrated control unit 12050.

The drive system control unit 12010 controls the operation of a device related to a vehicle drive system according to various programs. For example, the drive system control unit 12010 functions as a driving force generator for generating a driving force of a vehicle, for example, an internal combustion engine or a driving motor, a driving force transmission mechanism for transmitting a driving force to wheels, a steering mechanism for adjusting a turning angle of a vehicle, and a control device such as a braking device that generates a braking force of a vehicle.

The body system control unit 12020 controls the operations of various devices mounted in the vehicle body, according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives the inputs of the radio waves or signals and controls a door lock device, a power window device, and lamps of the vehicle.

The vehicle external information detection unit 12030 detects information on the outside of the vehicle having the vehicle control system 12000 mounted thereon. For example, an imaging unit 12031 is connected to the vehicle external information detection unit 12030. The vehicle external information detection unit 12030 causes the imaging unit 12031 to capture an image of the outside of the vehicle and receives the captured image. The vehicle external information detection unit 12030 may perform object detection processing or distance detection processing for persons, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The vehicle internal information detection unit 12040 detects information on the inside of the vehicle. For example, a driver state detection unit 12041 that detects a driver's state is connected to the vehicle internal information detection unit 12040. The driver state detection unit 12041 may include, for example, a camera that captures an image of a driver, and the vehicle internal information detection unit 12040 may calculate the degree of fatigue or concentration of the driver on the basis of detection information input from the driver state detection unit 12041 or may determine whether the driver is dozing or not.

The microcomputer 12051 can calculate a control target value of the driving force generator, the steering mechanism, or the braking device on the basis of information acquired about the outside or the inside of the vehicle by the vehicle external information detection unit 12030 or the vehicle internal information detection unit 12040 and output a control command to the drive system control unit 12010. For example, the microcomputer 12051 can perform cooperative control for the purpose of obtaining functions of an ADAS (Advanced Driver Assistance System) including collision avoidance or impact mitigation of a vehicle, following traveling based on inter-vehicle distance, vehicle speed maintenance driving, vehicle collision warning, or vehicle lane deviation warning or the like.

Furthermore, the microcomputer 12051 can perform cooperative control for the purpose of automated driving or the like in which autonomous travel is performed without depending on operations by the driver, by controlling the driving force generator, the steering mechanism, or the braking device or the like on the basis of information about the surroundings of the vehicle, the information being acquired by the vehicle external information detection unit 12030 or the vehicle internal information detection unit 12040.

In addition, the microcomputer 12051 can output a control command to the body system control unit 12020 on the basis of the information acquired about the outside of the vehicle by the vehicle external information detection unit 12030. For example, the microcomputer 12051 can perform cooperative control for the purpose of preventing glare by controlling the headlamps to switch a high beam to a low beam according to the position of a vehicle ahead or an oncoming vehicle that is detected by the vehicle external information detection unit 12030.

The audio/image output unit 12052 transmits an output signal of at least one of sound and an image to an output device capable of visually or audibly notifying a passenger or the outside of the vehicle about information. In the example of FIG. 17, an audio speaker 12061, a display unit 12062, and an instrument panel 12063 are illustrated as output devices. For example, the display unit 12062 may include at least one of an on-board display and a head-up display.

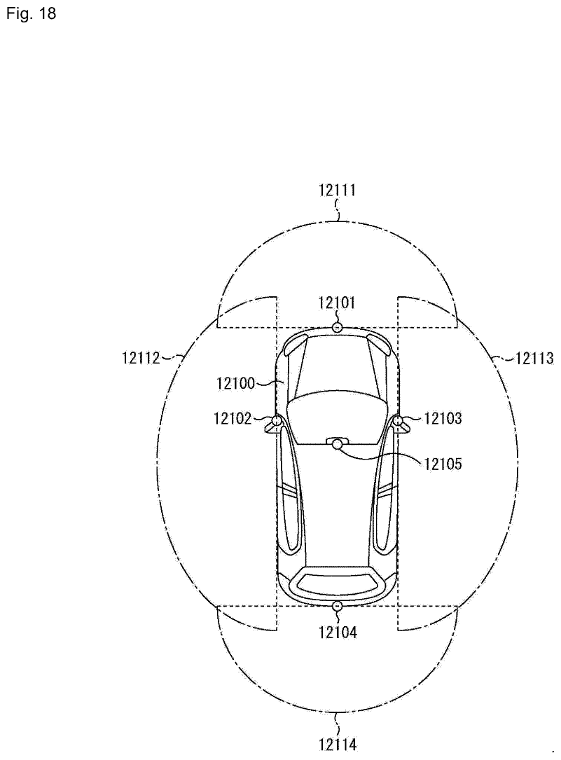

FIG. 18 illustrates an example of the installation position of the imaging unit 12031 according to an embodiment of the present technique.

In FIG. 18, a vehicle 12100 includes imaging units 12101, 12102, 12103, 12104, and 12105 as the imaging unit 12031.

The imaging units 12101, 12102, 12103, 12104, and 12105 are provided at positions such as a front nose, side-view mirrors, a rear bumper, a back door, and an upper portion of a windshield in the interior of the vehicle 12100. The imaging unit 12101 provided at the front nose and the imaging unit 12105 provided in an upper portion of the windshield in the interior of the vehicle mainly capture images ahead of the vehicle 12100. The imaging units 12102 and 12103 provided at the side-view mirrors mainly capture images on the sides of the vehicle 12100. The imaging unit 12104 provided at the rear bumper or the back door mainly captures images behind the vehicle 12100. Front view images captured by the imaging unit 12101 and 12105 are mainly used for detecting a vehicle ahead, pedestrians, obstacles, traffic lights, traffic signs, or lanes or the like.

FIG. 18 also shows an example of the imaging ranges of the imaging units 12101 to 12104. An imaging range 12111 indicates the imaging range of the imaging unit 12101 provided at the front nose, imaging ranges 12112 and 12113 respectively indicate the imaging ranges of the imaging units 12102 and 12103 provided at the side-view mirrors, and an imaging range 12114 indicates the imaging range of the imaging unit 12104 provided at the rear bumper or the back door. For example, a bird's-eye view image of the vehicle 12100 viewed from above can be obtained by superimposing pieces of image data captured by the imaging unit 12101 to 12104.

At least one of the imaging units 12101 to 12104 may have the function of acquiring distance information. For example, at least one of the imaging units 12101 to 12104 may be a stereo camera including a plurality of imaging elements or may be an imaging element that has pixels for phase difference detection.

For example, the microcomputer 12051 can extract, particularly, the closest three-dimensional object on the travel path of the vehicle 12100, which is a three-dimensional object traveling at a predetermined speed (for example, 0 km/h or higher) in the substantially same direction as the vehicle 12100, as a vehicle ahead by acquiring a distance to each three-dimensional object in the imaging ranges 12111 to 12114 and a temporal change of this distance (a relative speed with respect to the vehicle 12100) on the basis of the distance information obtained from the imaging units 12101 to 12104. Furthermore, the microcomputer 12051 can set an inter-vehicle distance to be secured from a vehicle ahead in advance and can perform automated brake control (also including following stop control) or automated acceleration control (also including following start control). Thus, cooperative control can be performed for the purpose of, for example, automated driving in which autonomous travel is performed without depending on operations by the driver.

For example, the microcomputer 12051 can classify and extract three-dimensional data on three-dimensional objects into two-wheeled vehicles, normal vehicles, large vehicles, pedestrians, and other three-dimensional objects such as electric poles on the basis of distance information obtained from the imaging units 12101 to 12104 and can use the three-dimensional data for automated avoidance of obstacles. For example, the microcomputer 12051 identifies obstacles in the vicinity of the vehicle 12100 as obstacles visually recognizable by the driver of the vehicle 12100 and obstacles difficult to visually recognize. The microcomputer 12051 then determines the risk of collision, that is, the degree of risk of collision with each obstacle and outputs a warning to the driver through the audio speaker 12061 or the display unit 12062 or performs forced deceleration or avoidance steering through the drive system control unit 12010 when the risk of collision is equal to or greater than a set value and thus collision may occur. Thus, driving assistance can be performed for collision avoidance.

At least one of the imaging units 12101 to 12104 may be an infrared camera that detects infrared rays. For example, the microcomputer 12051 can recognize a pedestrian by determining the presence or absence of a pedestrian in the captured images of the imaging units 12101 to 12104. The pedestrian is recognized by, for example, the step of extracting feature points in the captured images of the imaging units 12101 to 12104 serving as infrared cameras, and the step of performing pattern matching processing on a series of feature points indicating the edge of an object to determine whether or not the object is a pedestrian. When the microcomputer 12051 determines that a pedestrian is present in the captured images of the imaging units 12101 to 12104 and recognizes the pedestrian, the audio/image output unit 12052 controls the display unit 12062 such that a square contour line for emphasis is superimposed and displayed on the recognized pedestrian. In addition, the audio/image output unit 12052 may control the display unit 12062 such that an icon or the like indicating a pedestrian is displayed at a desired position.

An example of the vehicle control system to which the technique according to the present disclosure (the present technique) can be applied has been described above. The technique according to the present disclosure is applicable to, for example, the driver state detection unit 12041 among the configurations described above. This can obtain the advantages of both of the rolling shutter method and the global shutter method, thereby improving the accuracy of detection.

The above description of the electronic device according to the fifth embodiment of the present technique can be applied to other embodiments of the present technique unless any particular technical contradiction arises.

Note that the embodiments of the present technique are not limited to the foregoing embodiments and various modifications can be made without departing from the gist of the present technique.

In addition, the present technique can also be configured as follows:

[1]

An imaging device including: a photoelectric conversion unit that converts light into charge;
an overflow transistor connected to the photoelectric conversion unit;
a transfer transistor connected to the photoelectric conversion unit;
a reset transistor connected to the transfer transistor;
a capacitor connected between the transfer transistor and the reset transistor; and
an amplifier transistor connected between the transfer transistor and the reset transistor.
   [2]

The imaging device according to [1], wherein when the overflow transistor is turned on, a signal generated by charge converted through the photoelectric conversion unit is read according to a first electronic shutter method, and when the overflow transistor is turned off, a signal generated by charge converted through the photoelectric conversion unit is read according to a second electronic shutter method.

[3]

The imaging device according to [2], wherein the first electronic shutter method is a global shutter method, and
the second electronic shutter method is a rolling shutter method.
   [4]

The imaging device according to any one of [1] to [3], further including a floating diffusion transistor connected between the transfer transistor and the reset transistor.

[5]

The imaging device according to any one of [1] to [4], wherein the reset transistor is turned on immediately before the transfer transistor is turned on.

[6]

The imaging device according to any one of [1] to [5], further including a select transistor connected to the amplifier transistor.

[7]

The imaging device according to any one of [1] to [6], wherein the overflow transistor is turned on or off on the basis of the moving speed of a subject to be captured by the imaging device.

[8]

The imaging device according to any one of [2] to [7], further including an image generation unit that generates an image on the basis of a read signal.

[9]

The imaging device according to [8], wherein the image generation unit generates an infrared light image according to a difference between a first image generated on the basis of light from a subject not irradiated with infrared light and a second image generated on the basis of light from the subject irradiated with infrared light.

[10]

The imaging device according to [9], wherein the first image and the second image are images generated on the basis of signals read according to the first electronic shutter method.

[11]

An electronic device including the imaging device according to any one of [1] to [10].

### REFERENCE SIGNS LIST

1 Imaging device
10 Pixel array
21 Scanning unit
22 Signal generation unit
40 Reading unit
50 Control unit
60 Signal processing unit
70 Measurement unit
80 Image generation unit
P Pixel
PD Photoelectric conversion unit
C Capacitor
OFG Overflow transistor
TRG Transfer transistor
RST Reset transistor
AMP Amplifier transistor
SEL Select transistor
FDG Floating diffusion transistor
SGL Vertical signal line
STRB Light source

1. An imaging device comprising: a photoelectric conversion unit that converts light into charge;
an overflow transistor connected to the photoelectric conversion unit;
a transfer transistor connected to the photoelectric conversion unit;
a reset transistor connected to the transfer transistor;
a capacitor connected between the transfer transistor and the reset transistor; and
an amplifier transistor connected between the transfer transistor and the reset transistor.

2. The imaging device according to claim 1, wherein when the overflow transistor is turned on, a signal generated by charge converted through the photoelectric conversion unit is read according to a first electronic shutter method, and when the overflow transistor is turned off, a signal generated by charge converted through the photoelectric conversion unit is read according to a second electronic shutter method.

3. The imaging device according to claim 2, wherein the first electronic shutter method is a global shutter method, and the second electronic shutter method is a rolling shutter method.

4. The imaging device according to claim 1, further comprising a floating diffusion transistor connected between the transfer transistor and the reset transistor.

5. The imaging device according to claim 1, wherein the reset transistor is turned on immediately before the transfer transistor is turned on.

6. The imaging device according to claim 1, further comprising a select transistor connected to the amplifier transistor.

7. The imaging device according to claim 1, wherein the overflow transistor is turned on or off on a basis of a moving speed of a subject to be captured by the imaging device.

8. The imaging device according to claim 2, further comprising an image generation unit that generates an image on a basis of a read signal.

9. The imaging device according to claim 8, wherein the image generation unit generates an infrared light image according to a difference between a first image generated on a basis of light from a subject not irradiated with infrared light and a second image generated on a basis of light from the subject irradiated with infrared light.

10. The imaging device according to claim 9, wherein the first image and the second image are images generated on a basis of signals read according to the first electronic shutter method.

11. An electronic device comprising the imaging device according to claim 1.
